(19) United States
(12) Patent Application Publication
(10) Pub. No.: US 2006/0120092 A1
(43) Pub. Date: Jun. 8, 2006

(54) Lighting system

(76) Inventor: Richard Sapper, Stuttgart (DE)

Correspondence Address: James C. Scheller;BLAKELY, SOKOLOFF, TAYLOR & ZAFMAN LLP, Seventh Floor, 12400 Wilshire Boulevard, Los Angeles, CA, 90025, US

(21) Appl. No.: 11/003,476

(22) Filed: Dec. 3, 2004

(51) Int. Cl. F21S 8/08; F21S 8/00

(52) U.S. Cl. 362/427; 362/410

(57) ABSTRACT

The present invention relates to a lighting system. In one exemplary embodiment, the lighting system provides multiple degrees of freedom of motion. The lighting system maintains a systematic equilibrium, such that once a light generating device on the lighting system is positioned within a range of locations, the light generating device will remain substantially in that position despite the force of gravity. The lighting system maintains continual electrical connectivity whether the light generating device is stationary or moving.

### FIELD OF INVENTION

The field of the invention relates to lighting systems, and in particular, in one exemplary aspect, a lighting system having multiple degrees of freedom of motion.

### BACKGROUND

Lighting systems are integral to modern society. The advent of the first electrical lighting system dates back to the late nineteenth century with the invention of the incandescent (or electric filament) lamp. Since then, improvements have continually been made. Many lighting systems now are specialized to include features particularly useful for certain purposes.

For example, lighting systems with articulated supports and springs have been developed for drawing boards to permit draftsmen to adjust the height of the light source over the table, or to illuminate selected areas of a drawing board. In many of these systems, a lamp support member connects to a base clamped to the edge of the board. These systems often rely on springs to provide at least one degree of freedom of motion.

In mechanical engineering, degrees of freedom (DOF) describe flexibility of motion. A mechanism that has complete freedom of motion, even if only in a limited space, has six degrees of freedom. Three modes are translational, each moving in one of three spacial dimensions (e.g. x, y, and z). Three modes are rotational, each changing angles around one of three perpendicular axes. The six degrees of freedom are often described as moving up and down (or heaving), moving left and right (or swaying), moving forward and backwards (or surging), tilting up and down (or pitching), turning left and right (or yawing), and tilting side to side (or rolling).

Although springs can provide devices with a DOF, with use and over time, springs develop slackness (i.e. a decrease in the spring constant). This slackness not only decreases the functionality of the lighting system, but may also become dangerous. In additional, exposed wiring (or cabling) near the articulations (or joints) also pose a danger to consumers.

### BRIEF DESCRIPTION OF THE DRAWINGS

Various aspects of the present invention are set forth in the following drawings in which:

FIG. 1 is a perspective view of a lighting system having six degrees of freedom in accordance with one embodiment of this invention.

FIG. 2A is a perspective view of a light generating device coupled to a support arm in accordance with one embodiment of this invention.

FIG. 2B is a side view of a light generating device coupled to a support arm in accordance with one embodiment of this invention.

FIG. 3 is a perspective view of a light generating device coupled to support arms in accordance with another embodiment of this invention.

FIG. 4 is a perspective view of a lighting system having two degrees of freedom in accordance with another embodiment of this invention.

FIG. 5 is a side view of a floor lighting system in accordance with one embodiment of this invention.

FIG. 6A is a side view of a base in accordance with one embodiment of this invention.

FIG. 6B is a top view of the base of FIG. 6A.

FIG. 7 is a top view of another base in accordance with one embodiment of this invention.

FIG. 8 is a cross-sectional view of electrical cables housed within joints and support arms in accordance with one embodiment of this invention.

### DETAILED DESCRIPTION

A lighting system providing, in at least certain embodiments, multiple degrees of freedom of motion is disclosed. In the following detailed description, numerous specific details are set forth in order to provide a thorough understanding of the present invention. However, it will be apparent to one of ordinary skill in the art that these specific details need not be used to practice the present invention. In other circumstances, well-known structures, materials or processes have not been shown or described in detail in order not to obscure unnecessarily the present invention.

Lighting systems are often described in terms of location. For example, a lighting system may be labeled a floor lamp, table lamp, wall lamp or ceiling lamp. The location of the lighting system may determine the appropriate dimensions or characteristics of the system. Floor lamps often have taller dimensions than many table lamps. Wall lamps often have lighter mass than many floor lamps.

Additionally, the location of the lighting system may restrict the potential positions the light generating device on the lighting system may occupy. For example, one embodiment of this invention provides a lighting system with a light generating device having six degrees of freedom. If the system is mounted on a wall, the wall may restrict the actual positions the light generating device may occupy, even though the device is capable of moving in six degrees. The light generating device cannot pass through the wall. In contrast, if the system stands on a floor, the actual positions the light generating device can occupy will generally be greater.

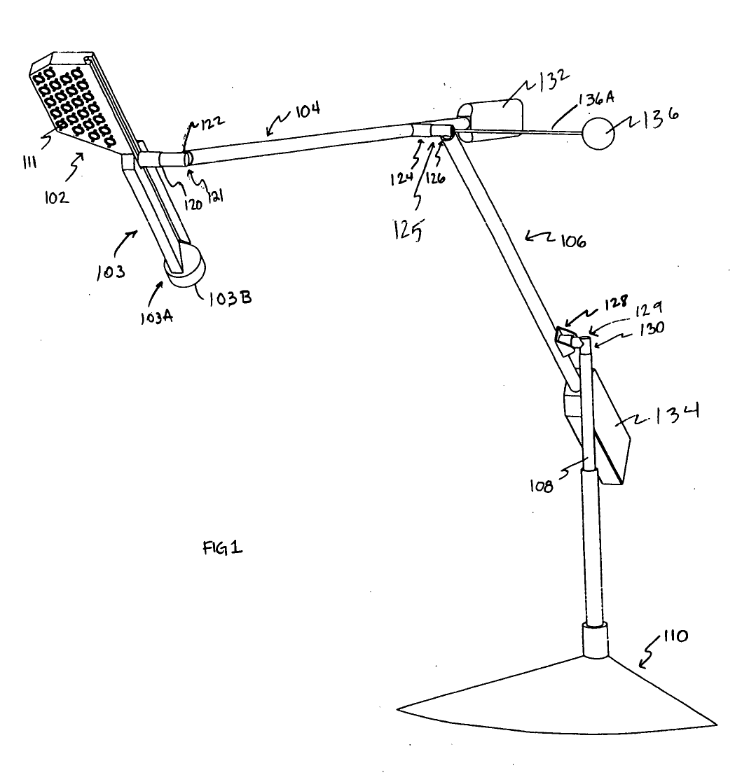

FIG. 1 shows one embodiment of a lighting system with six degrees of freedom. Generally, light source 111 is coupled (by joints 120 and 122 which form combination joint 121) to first support arm 104, which is coupled (by joints 124 and 126 which form combination joint 125) to support arm 106, which is coupled (by joints 128 and 130 which form combination joint 129) to third support arm 108, which is coupled to base 110. Light source 111 has complete freedom of movement, i.e. light source 111 has six degrees of freedom of motion (heave, sway, surge, pitch, yaw and roll) relative to base 110 through articulation of the three combination joints 121, 125 and 129. The freedom of motion is within a spherical volume whose radius is the distance from the coupling joining second support arm 106 and third support arm 108 to light source 111. In FIG. 1, this coupling is combination joint 129. Light source 111 is mounted on light generating device 102.

The light generating device 102 includes, at least in certain embodiments, a counterweight structure 103 which is coupled to the light source 111. This counterweight structure may also function as a heat sink by absorbing and conveying heat from light source 111 toward the end 103A of the counterweight structure. An optional fan 103B is attached to the end 103A, and this fan may further reduce the operating temperature of the light source 111 thereby allowing the user to grasp the light source, while it is generating light (and heat) and to move it.

The joint 120 may be coupled to the light generating device 102 at (or near) the center of gravity of the light generating device 102 (e.g. between the light source 111 and the counterweight structure 103). If coupled in this way, the counterweight of counterweight structure 103 may counterbalance the weight of light source 111 such that the light generating device 102 is balanced at any rotational position set by a user even if the joint has relatively low friction. This enables a user to rotate the light generating device 102 around the joint 120 with very little applied force (e.g. with the push of a finger) and yet the device 102 will remain fixed at any new position because of the balance provided by the counterweight structure 103.

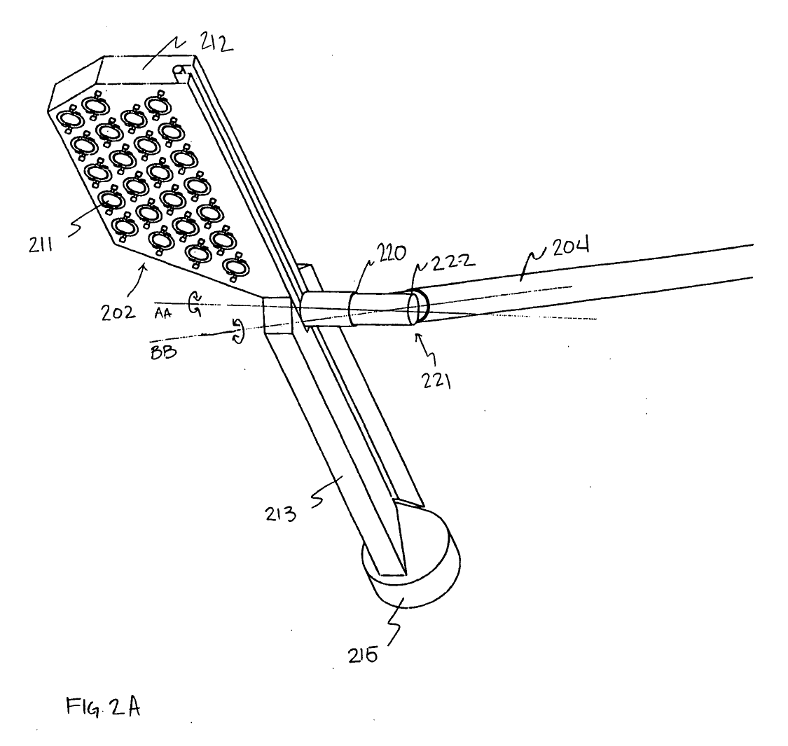

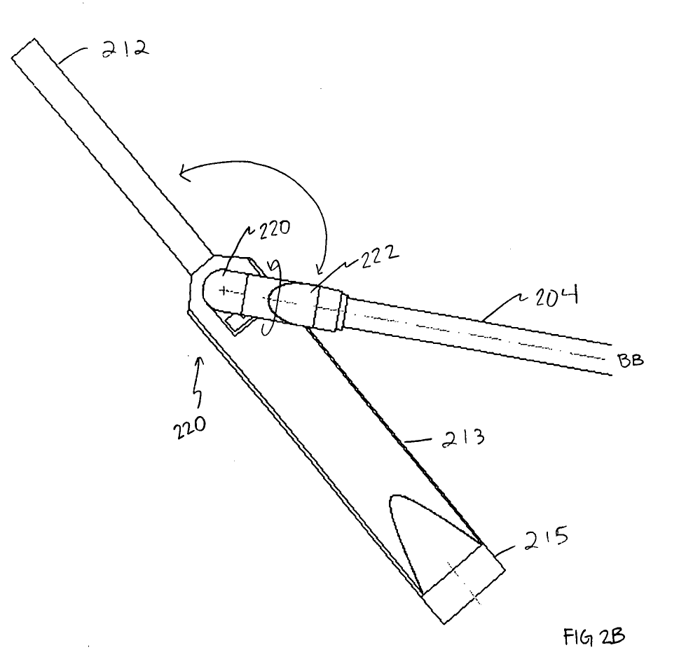

The joint 120 allows rotation of the light generating device 102 around an axis defined by the axial direction of the joint 120; the axis AA shown in FIG. 2A illustrates an example of such an axis. The joint 122 is coupled to joint 120, and joint 122 allows the light generating device 102 to be rotated around an axis defined by the axial direction of support arm 104; the axis BB shown in FIG. 2A illustrates an example of such an axis. The joint 122 is coupled to the first support arm 104.

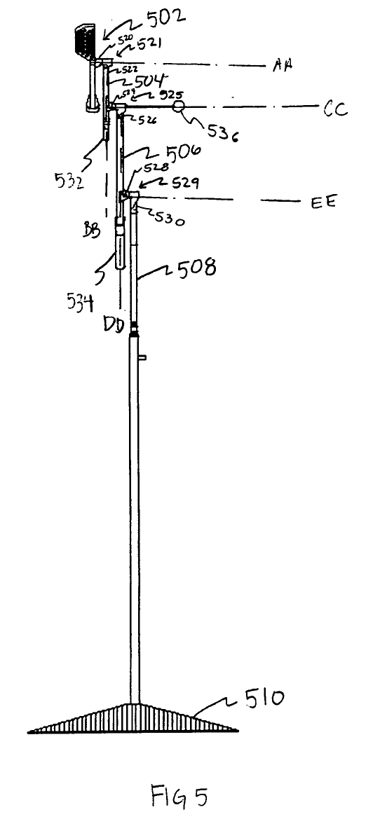

The first support arm 104 extends from joint 122 to the counterweight 132. A joint 124 may be coupled to the first support arm 104 at or near the center of gravity of the first support arm 104 and the objects attached to it (which objects include the light generating device 102 and joints 120 and 122 and the counterweight 132). When the joint 124 is coupled at or substantially near this center of gravity, first support arm 104 can be rotated, around an axis defined by an axial direction of joint 124, to any new rotational position and will remain fixed in that new position (without requiring locks or brakes or significant friction at the joint 124). The axis CC shown in FIG. 5 illustrates an example of an axis defined by the axial direction of joint 124.

A joint 126 is coupled, at one end of joint 126, to joint 124 and is coupled, at another end of joint 126, to support arm 106. The joint 126 allows rotation of the support arm 104 around an axis defined by the axial direction of support arm 106; the axis DD shown in FIG. 5 illustrates an example of such an axis which is defined by the axial direction of support arm 106.

The support arm 106 extends from joint 126 to the counterweight 134 which is coupled, in this exemplary embodiment, to an end of support arm 106. The joint 128 may be coupled to the support arm 106 at or near the center of gravity of the support arm 106 and the objects attached to it (which objects include the counterweight 134 and the support arm 104 and the objects attached to the support arm 104). When the joint 128 is coupled at or near this center of gravity, the support arm 106 can be rotated, around an axis defined by the axial direction of joint 128, to any new rotational position and will remain fixed in that new position (without requiring locks or brakes or significant friction). The axis EE shown in FIG. 5 illustrates an example of such an axis which is defined by the axial direction of joint 128. The joint 128 is coupled to joint 130 which in turn is coupled to support arm 108. Joint 130 allows rotational movement around an axis defined by an axial direction of joint 130 which is parallel to the lengthwise axis of support arm 108. Thus, joint 130 allows support arm 106 (and all components coupled to it) to rotate around this axis. The support arm 108 is coupled to the base 110 which may be used to place the lighting system on a desk or a table or a floor or a wall or on another surface. It will be appreciated that joint 130 may be coupled to the base 110 so that the joint 130 is between base 110 and support arm 108, and, in this case, the support arm 108 is coupled to joint 128.

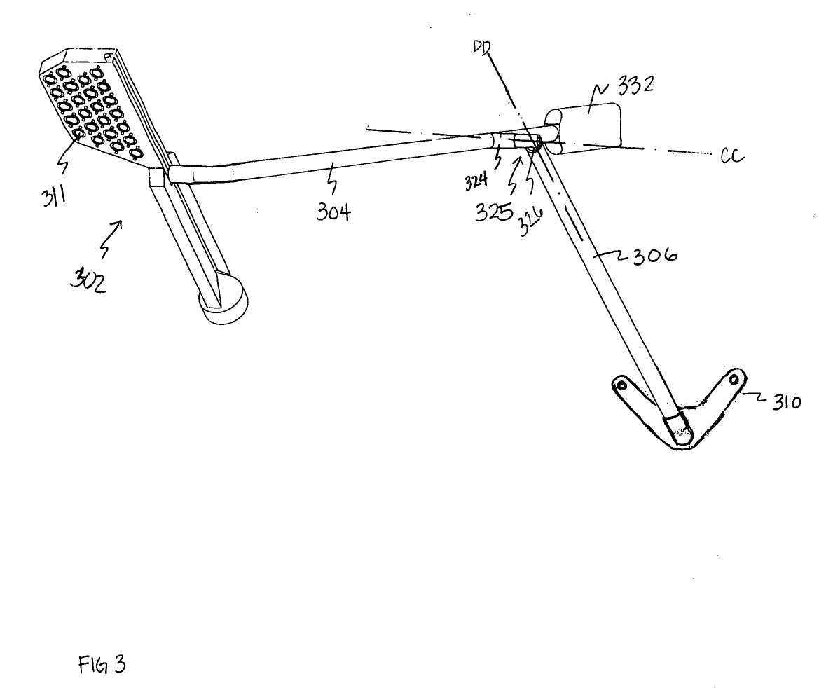

The lighting system shown in FIG. 1 also includes a counterweight 136 which serves to balance the support arm 104 (and the objects coupled to it including the counterweight 132 and the light generating device 102) relative to joint 126. The counterweight 136 is coupled to the joint 126 by arm 136A. The joint 126 may be positioned at the center of gravity of the structure which includes arm 136A, counterweight 136 and the support arm 104 (and the objects directly attached to arm 104). The weight and position of counterweight 136 (and the length of arm 136A) may be adjusted so that this center of gravity substantially coincides with the position of joint 126 on the axis DD shown in FIG. 3.

FIG. 2A is a perspective view of a light generating device 202 coupled to a first support arm 204, which is similar to first support arm 104 of FIG. 1. In FIG. 2A, light source 211 is one of many possible light sources mounted on platform 212. Platform 212 also includes circuitry to transmit power to light source 211.

In one embodiment, each light source emits similar wavelengths of light. In another embodiment, some light sources emit wavelengths of light different from other light sources mounted on the same platform (e.g. one group of light sources emits generally blue light, another group emits generally green light and another group emits generally red light). In another embodiment, rather than several light sources, one light source is mounted on the light generating device. In one embodiment, the light source is a light emitting diode (LED) or a plurality of LEDs. In another embodiment, the light source is an incandescent bulb (e.g. halogen) or fluorescent bulb. In another embodiment, the light source emits electromagnetic radiation with wavelengths outside the visible light spectrum only.

In FIG. 2A, light generating device 202 includes a thermal cooling device. The thermal cooling device includes heat sink 213 and cooling fan 215 coupled to platform 212. Heat sink 213 and cooling fan 215 convey thermal energy away from light source 211 and the related circuitry. In this embodiment, the thermal cooling device also provides a force to counter balance the weight of the platform, including the components mounted on or housed within the platform (e.g. the thermal cooling device acts as a counterweight to balance the platform 212). In one embodiment, the thermal cooling device includes either a heat sink or a cooling fan or both. In another embodiment, the light generating device does not require a thermal cooling device. In another embodiment, the thermal cooling device is mounted inside the platform. In another embodiment, the thermal cooling device is mounted on the platform opposite the side on which the light source is mounted. In such an embodiment, the thermal cooling device may not provide a force to counter-balance the weight of the platform.

In one embodiment, the light generating device is approximately 240 mm long by 57 mm wide, the platform is approximately 106 mm long by 43 mm wide, and the thermal cooling device is approximately 134 mm long and 28 mm thick.

In one embodiment, the light generating device is fixedly attached to a support arm. In FIG. 2A, light generating device 202 is moveably coupled to support arm 204 through joints 220, 222. Joint 220 enables light generating device 202 to rotate about axis AA defined by the rotational axis of joint 220, thus providing a rotational DOF. Axis AA is perpendicular (in one embodiment) to an axis defined by support arm 204. In another embodiment, axis AA is angled, but not perpendicular, to the axis defined by support arm 204. In another embodiment, joint 220 provides light generating device with a different degree of freedom. An example of a joint, which may be used for joint 220 and other joints described herein (such as joints 120, 122, 124, 126, 128 and 130), is described in U.S. patent application Ser. No. ______, filed on the same date as this application and entitled “Joint System” and showing John Tang as an inventor and having attorney docket No. 007144.P003; this application is incorporated herein by reference.

Joint 220 is coupled to light generating device 202 such that the center of gravity of light generating device 202 (including the platform 212 and the heat sink 213 and cooling fan 215) coincides substantially with axis of rotation AA. In one embodiment, the center of gravity of light generating device 202 coincides with the location where platform 212 and thermal cooling device 213, 215 join. Thermal cooling device 213, 215 then acts as a counter-weight to platform 212, balancing light generating device 202 on a fulcrum defined by joint 220. Light generating device 202 is balanced such that once placed in a particular position, light generating device 202 will remain substantially in that position despite the force of gravity. Joint 220 provides a minimal frictional dampening force (such that, for example, the entire light generating device 202 can be rotated with the touch of a finger.) In an embodiment in which the thermal cooling device is not sufficient to provide an adequate counter-balancing force, a separate counterweight may be coupled to the thermal cooling device.

In FIG. 2B, axis AA (not shown) is perpendicular to the drawing. Joint 220 allows light generating device 202 to rotate clockwise or counterclockwise around axis AA. In one embodiment, the light generating device may rotate 360 degrees around axis AA an indefinite number of times even though there are electrical wires within the structure. In another embodiment, the light generating device may rotate 360 degrees around axis AA a limited number of times in one direction before it must rotate in the other direction. In another embodiment, the light generating device is capable of rotating less than 360 degrees around axis AA.

In embodiments in which the thermal cooling device is mounted within platform 212, a separate counterweight is coupled to platform 212 to counter-balance the weight of platform 212. In embodiments in which a separate counterweight is not desired, joint 220 couples to platform 212 substantially near the platform's center of gravity. In embodiments in which platform 212 includes more than one light source, some light sources may be on one side of axis M and other light sources on another side of axis AA.

In one embodiment, joint 220 attaches directly to support arm 204. In the embodiment of FIG. 2A, joint 220 is coupled to joint 222. Joint 222 enables light generating device 202 to have a second DOF. Here, the second DOF is rotation about axis BB defined by joint 222. Here, axis BB is perpendicular to axis AA and is parallel with the lengthwise axis of support arm 204. Together, joint 220 and 222 enable light generating device 202 (and therefore light source 211) to move in two non-planar directions.

In FIG. 2B, joint 222 allows light generating device 202 to rotate clockwise or counterclockwise around axis BB. In one embodiment, the light generating device may rotate 360 degrees around axis BB an indefinite number of times even though there are electrical wires within the structure. In another embodiment, the light generating device may rotate 360 degrees around axis BB a limited number of times in one direction before it must rotate in the other direction. In another embodiment, the light generating device rotates less than 360 degrees around axis BB. In one embodiment, axis AA is non-orthogonal to axis BB. In those embodiments, the length of light generating device 202 limits the rotation of light generating device 202. If support arm attaches axially to joint 222, as shown in FIG. 2B, a longer light generating device may, for example, collide into support arm 204, depending on the angle between axis AA and BB.

In one embodiment, support arm 204 is a hollow rod. In one embodiment, rod 204 houses at least one electrical cable (not shown) to provide electrical power to the light source. In one embodiment, one cable provides four electrically conductive lines: two to power light source 211, one for a common ground, and one to power cooling fan 215. In another embodiment, two separate cables are provided: one to power light source 202 and one to power cooling fan 215. Other embodiments may include any combination of cables and conductive lines within a cable.

In one embodiment, the cable remains stationary as light generating device 202 moves relative to support arm 204, neither stretching nor twisting relative to support arm 204. The cable is capable of providing continuous electrical connectivity whether light generating device 202 is stationary or mobile. The joints used in at least certain embodiments provide a continuous electrical connection for the various conductors from one side of a joint to the other side of the joint, and this continuous electrical connection is maintained through the full range of motions available from the joint. This may be accomplished by including an electrical jack and an electrical plug, in each joint, which can rotate relative to each other. An example of such a joint is described in the above noted patent application having attorney docket No. 007144.P003.

In another embodiment, support arm 204 is a solid rod. In one embodiment, an inner cylindrical core of support arm 204 is made of conductive material, e.g. copper, to transmit an electrical signal, e.g. a power or ground signal, to light generating device 202. This inner core may be concentrically surrounded by an electrically insulating material, e.g. a dielectric, which is then concentrically surrounded by a conductor that transmits a second electrical signal, e.g. a power signal to a cooling fan. More insulating and conductive layers may surround this second conductive layer repeatedly to provide as many conductive signal lines as required.

In one embodiment, support arm 204 is cylindrical, having a circular cross-section. In another embodiment, support arm 204 is a rod having a non-circular outer cross-section, e.g. rectangular, triangular or elliptical. In another embodiment, support arm 204 has a cylindrical opening at one end to attach to joint 222.

In one embodiment, support arm 204 is attached directly to a base. In one embodiment, support arm is fixedly attached to the base, so that the lighting system has a total of two rotational DOFs. In another embodiment, support arm is movably attached to the base through a joint that provides a translation degree of freedom, so that the lighting system has a total of three degrees of freedom.

In FIG. 3, support arm 304 couples to support arm 306. In one embodiment, support arm 306 attaches to wall mount 310. In another embodiment, support arm 306 attaches to a base which stands on a floor or table. Support arm 304 is fixedly coupled to light generating device 302 at one end and detachable counterweight 332 at another end. Combination joint 325 provides two degrees of freedom, one degree through joint 324 and a second degree through joint 326. Joints 324 and 326 may be rotational joints such as those described in the U.S. patent application having attorney docket No. 007144.P003. Combination joint 325 attaches to support arm 304 at a location that coincides substantially with the center of mass of support arm 304 and all the components support arm 304 supports (e.g. light generating device 302 and counterweight 332).

Counterweight 332 provides the force necessary to balance light generating device 302 so that once support arm 304 is rotated into a position, support arm 304 will be balanced and remain substantially in that position, despite the force of gravity. For example, if support arm 304 is rotated into a horizontal position, it will remain substantially horizontal. Light generating device 302 and part of support arm 304, on the one side of joint 324, is counter-balanced by counterweight 332 and part of support arm 304, on the other side of joint 324. If support arm 304 is placed in a vertical position, it will also remain substantially vertical. If support arm 304 is placed at an angle relative to the gravitational force, it will also remain substantially at that angle. Joint 324, in one exemplary embodiment, provides a minimal frictional dampening force.

In one embodiment, counterweight 332 is metal, e.g. steel or brass. In one embodiment, counterweight 332 is approximately 0.6 lbs, 150 mm in length, 32 mm width, and 12 mm thick. In one embodiment, support arm 304 snaps into counterweight 332 and extends approximately 30 mm into counterweight 332. In another embodiment, counterweight 332 includes a threaded opening, which allows counterweight 332 to screw onto threads on support arm 304. In another embodiment, counterweight 332 attaches to support arm 304 using a twist lock. In yet another embodiment, counterweight 332 attaches to support arm 304 using adhesive (e.g. glue).

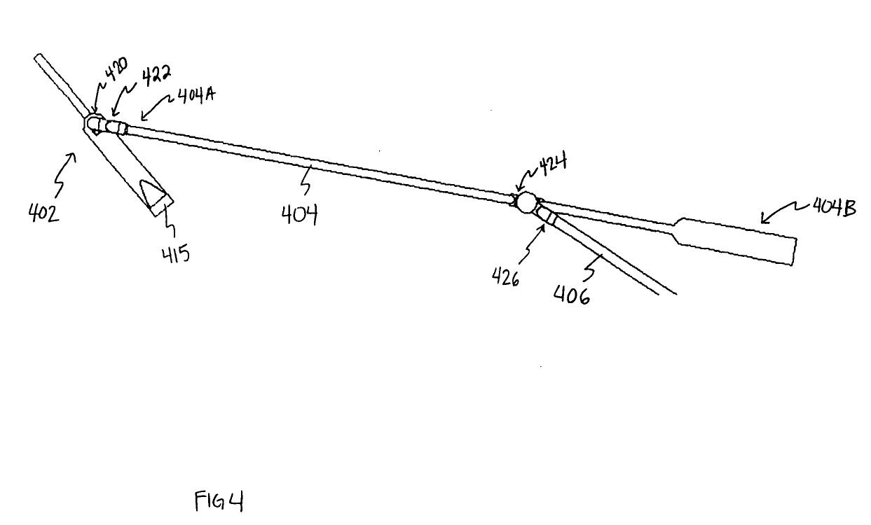

FIG. 4 shows an embodiment without a detachable counterweight. In FIG. 4, light generating device 402 (including cooling fan 415) is coupled by joints 420 and 422 to first support arm 404 at end 404A, which is coupled by joints 424 and 426 to support arm 406. Rather than coupling to a counterweight at end 404B, in this embodiment, support arm 404 is more massive at end 404B. The more massive end acts as a counterweight, thereby eliminating, or substantially reducing, the need for a detachable counterweight.

In FIG. 3, counterweight 332 couples to support arm 304, which couples to joint 324, which couples to joint 326. Joint 326 couples to support arm 306. In one embodiment, axis CC defined by joint 324 is perpendicular to axis DD defined by joint 326. In one embodiment, the both joints (324, 326) provide rotational movement to support arm 304, and thereby provides two additional degrees of freedom of rotational movement to light source 311 relative to support arm 306.

In one embodiment, combination joint 325 couples to support arm 304 orthogonally, such that the lengthwise axis of support arm 304 is 90 degrees relative to axis CC defined by joint 324. Combination joint 325 couples to support arm 306 axially, such that the lengthwise axis of support arm 306 is parallel to axis DD defined by joint 326. In another embodiment, combination joint 325 couples to support arms 304, 306 neither perpendicularly nor axially.

When support arm 304 is coupled orthogonally to combination joint 325 and support arm 306 is coupled axially to combination joint 325, and when light generating device 302 is fixedly coupled to support arm 304, then the light generating device 302 can be positioned in a range of locations approximately defined by the outer surface of a sphere. The sphere's center is defined by combination joint 325. The sphere's radius is approximately defined by the distance between combination joint 325 and light generating device 302. This range of positions excludes locations that would require any of the lighting system's components to coexist in the same spatial coordinates at the same time. The sizes and weights of the components of the lighting system (and the location of the joints within the system) may be selected so that the components are in static equilibrium without the use of locks or brakes or significant fiction in the rotational joints.

In one embodiment, light generating device 302 couples to support arm 304 through a combination joint (not shown) that provides two additional degrees of freedom. In such a lighting system, light generating device 302 has four DOF relative to support arm 306. When each of the two combination joints provide two rotational DOF, then the light generating device 302 can be positioned in a range of locations approximately defined by the volume of a spherical shell. The sphere's center is defined by combination joint 325. The inner radius of the spherical shell is defined by the distance between combination joint 325 and the combination joint coupling light generating device 302 to support arm 304, minus the distance between the latter combination joint and the end of the light generating device 302. The outer radius of the spherical shell is defined by the distance between combination joint 325 and the combination joint coupling light generating device 302 to support arm 304, plus the distance between the latter combination joint and the end of the light generating device 302. This range of positions excludes locations that would require any of the lighting system's components to coexist in the same spatial coordinates at the same time.

The embodiment shown in FIG. 5 is similar to the embodiment shown in FIG. 1. In FIG. 5, support arm 506 couples to support arm 508 through combination joint 529. Combination joint 529 includes joints 528, 530. In one embodiment, joint 528 provides one degree of freedom of rotational motion, and joint 530 provides another degree of freedom of rotational motion. Together, joints 520, 522, 524, 526, 528 and 530 provide light generating device 502 with six degrees of freedom of motion relative to support arm 508, which is coupled to the base 510.

Combination joint 529 couples to support arm 506 between combination joint 525 at one end and counterweight 534 at another end. This coupling location coincides substantially with the center of mass of support arm 506 and the components support arm 506 supports (e.g. light generating device 502, support arm 504, and counterweights 532,534). Counterweight 534 provides the force necessary to balance support arm 506 and the components support arm 506 support, such that once support arm 506 is rotated into a position, support arm 506 will balance and remain substantially in that position without the use of locks or brakes or significant friction in the combination joint 529, despite the force of gravity. Thus, in this embodiment, the lighting system is concurrently capable of a systematic equilibrium and six degrees of freedom.

In one embodiment, counterweight 536 (which is similar to counterweight 136 in FIG. 1) attaches to joint combination 525, parallel to axis CC defined by joint 524, to facilitate the balancing of support arm 506 on combination joint 529. Counterweight 536 is located on a side of axis DD opposite the side on which support arm 504 is located. In one embodiment, counterweight 536 includes a threaded rod and a solid brass sphere approximately 25 mm in diameter. In that embodiment, the distance from the brass sphere to combination joint 525 is approximately 140 mm long.

The weights of the lighting system's components (e.g. the light generating device, joints, support arms and counterweights) provide for a systematic equilibrium (a static equilibrium of forces), such that light generating device 502 can be positioned in a range of locations approximately defined by the volume of a sphere without the use of locks or brakes or significant friction in the joints. The sphere's center is defined by combination joint 529. The sphere's radius is approximately defined by the distance between combination joint 529 and combination joint 525 (which includes joints 524 and 526), plus the distance between combination joint 525 and combination joint 521 (which includes joints 520 and 522), plus the distance between combination joint 521 and the end of light generating device 502. This range of positions excludes locations that would require any of the lighting system's components to coexist in the same spatial coordinates at the same time. These possible positions also exclude positions that would require any of the lighting system's components to extend beyond the plane defined by the bottom of base 510.

In one embodiment, the overall dimensions of the lighting system are small enough such that counterweights are no longer required to provide the systematic equilibrium previously discussed. Frictional forces between the joints and those components coupled to the joints provide the balancing force required to achieve systematic equilibrium. Still, the frictional forces between the joints and those components coupled to the joints are sufficiently low such that minimal force need be applied to adjust the position of the light generating device relative to the base.

In one embodiment, the length of support arm 504 is approximately 10% of the length of support arm 508 and the length of support arm 506 is approximately 25% in length of support arm 508. In another embodiment, the length of support arm 504 is approximately 900 mm and the length of support arm 508 is approximately 1200 mm. In one embodiment, support arm 504 is smaller in diameter than support arm 506, which is smaller in diameter than support arm 508.

In one embodiment, the lengths of the support arms may vary 10%-15% without varying the weights of the counterweights. In another embodiment, varying the length of a support arm requires varying the weight of a counterweight correspondingly, such that a systematic equilibrium is maintained without the use of locks or brakes or significant friction in the joints. Generally, depending on the mass of the support arm, a shorter support arm will require a heavier counterweight and a longer support arm will generally require a lighter counterweight. It will also be appreciated that, at least in certain alternative embodiments, some or all of the joints may include a lock or brake or significant friction so that smaller counterweights (or no counterweights) are required for the support arms.

In one embodiment, particularly useful for standing on floors or tables, the distance between axis AA and axis CC is approximately 500 mm. The distance between axis CC and the end of support arm 504 coupled to counterweight 532 is approximately 200 mm. Support arm 504 extends approximately 30 mm into counterweight 532, which is approximately 150 mm long. The distance between axis CC and the end of counterweight 532 is approximately 300 mm. Counterweight 532 weighs less than one pound. The distance between axis DD and the end of counterweight 536 is approximately 150 mm long. The diameter of the spherical ball associated with counterweight 536 is approximately 25 mm. The distance between axis CC and axis EE is approximately 400 mm long. The distance between axis EE and the end of support arm 506 is approximately 150 mm. Support arm 506 extends approximately 30 mm into counterweight 534, which is approximately 150 mm long. The distance between axis EE and the end of counterweight 534 is approximately 300 mm. Counterweight 534 weighs approximately two pounds. The distance between axis EE and the bottom of base 510 is approximately 300 mm. The angle between support arm 508 and base 510 is approximately 80 degrees. The distance along support arm 508 between axis EE and the bottom of base 510 is approximately 300 mm. Base 510 is approximately 200 mm wide and approximately six pounds.

In another embodiment, varying the length of the support arm requires adjusting the location of the joint relative to the support arm. The joint is relocated to ensure that the rotation axis defined by the rotational joint remains at (or near) the center of gravity of the support arm and the components the support arm supports.

In one embodiment, the distance between axis AA and axis CC is 540 mm. The distance between axis CC and the end of support arm 504 is 184 mm. Support arm 504 extends 30 mm into counterweight 532, which is 150 mm long. The distance between axis CC and the end of counterweight 532 is 334 mm. Counterweight 532 weighs 0.6 lbs. The distance between axis DD and the end of counterweight 536 is 173 mm long. The diameter of the spherical ball associated with counterweight 536 is approximately 25 mm. The distance between axis CC and axis EE is 362.5 mm long. The distance between axis EE and the end of support arm 506 is 143.5 mm. Support arm 506 extends 30 mm into counterweight 534, which is 156 mm long. The distance between axis EE and the end of counterweight 534 is 269.5 mm. Counterweight 534 weighs 2.2 lbs. The perpendicular distance between axis EE and the bottom of base 510 is 310.07 mm. The angle between support arm 508 and base 510 is approximately 82 degrees. The distance along support arm 508 between axis EE and the bottom of base 510 is approximately 313.12 mm. Base 510 is 210.3 mm wide and 5.75 lbs.

In another embodiment, particularly useful for standing on tables or mounting to walls, the lighting system's dimensions are approximately 80% of the dimensions particularly useful for lighting systems which stand on floors. In one embodiment, the distance between axis AA and axis CC is 432 mm. The distance between axis CC and the beginning of counterweight 532 is 130.99 mm. The distance between axis CC and axis EE is 290 mm long. The distance between axis EE and the beginning of counterweight 534 is 102.97 mm. The perpendicular distance between axis EE and the bottom of base 510 is 290.76 mm.

In another embodiment, joint 528 is a rotational joint and joint 530 is a fixed joint. To provide the sixth degree of freedom, a movable (e.g. rotational) joint attaches support arm 508 to base 510.

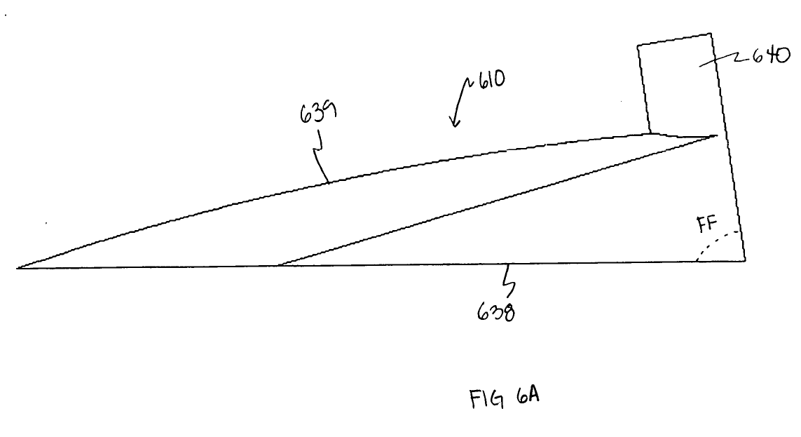

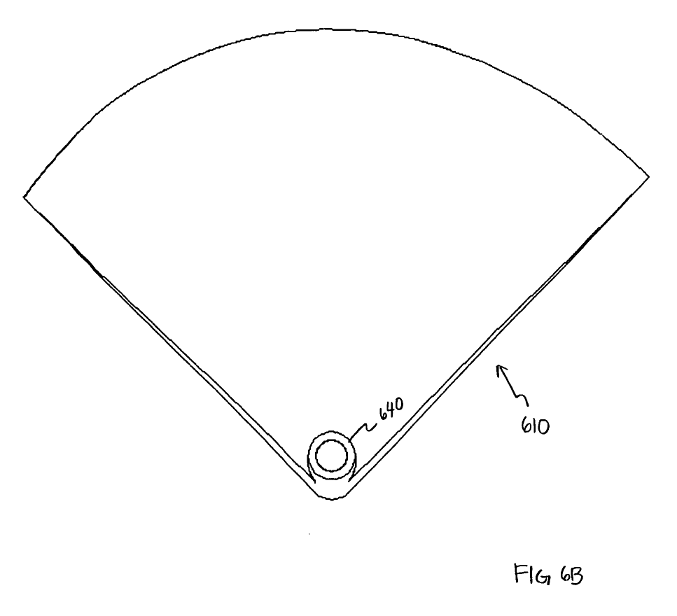

FIG. 6A is a side view of a base in accordance with one embodiment of this invention. Base 610 has a bottom surface 638 and a top surface 639. Top surface 639 is angled relative to bottom surface 639. In one embodiment, top surface 639 has a generally rounded surface with a slope which is directed towards bottom surface 639. Support arm (not shown) couples to transition housing 640, so as to form an angle FF with bottom surface 369. In the embodiment shown, angle FF is slightly less than 90 degrees (e.g. 82 degrees). In another embodiment, angle FF is 90 degrees. In one embodiment, transition housing 640 is located near an edge of base 610. In one embodiment, transition housing 640 is near an edge that is further from the bottom surface than an opposing edge. This embodiment provides a surface on which objects (e.g. paper) may be placed partially on top surface 639, and partially on the surface upon which the base connects (e.g. a floor or table).

FIG. 6B is a top view of the base of FIG. 6A. In this embodiment, transition housing 640 has a circular inner cross-section to fit a cylindrical support arm. In another embodiment, transition housing 640 has an inner cross-section which corresponds to a differently shaped support arm.

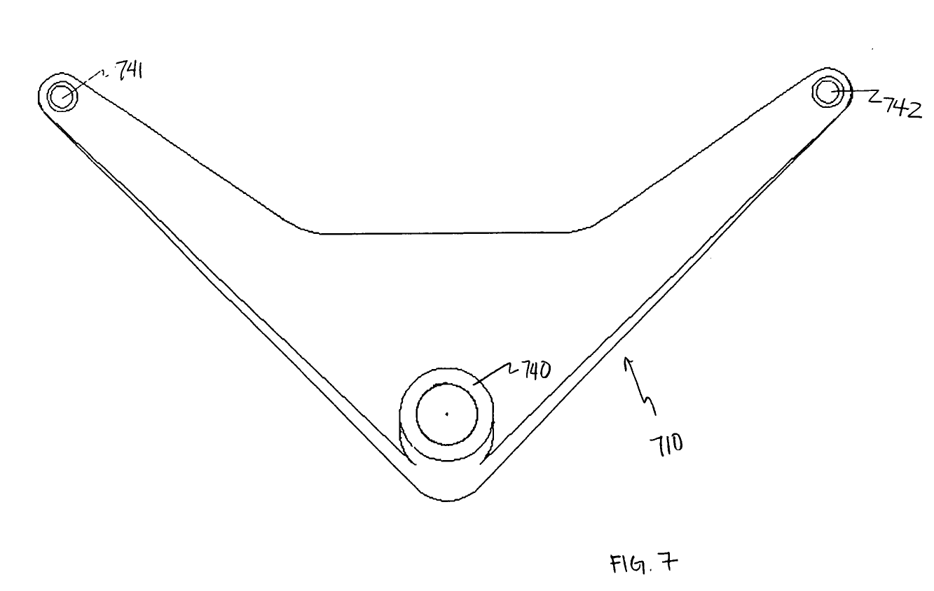

FIG. 7 shows one embodiment of a base capable of fastening to a surface (e.g. a wall). Fasteners (e.g. screws, nails or bolts) fit through openings 741, 742 and attach base 710 to the surface. For lighting systems of this invention that stand on a floor or table, a fastener is not required to attach the base to a floor or table.

In another embodiment, the base contains at least a controller (e.g. a current controller or voltage controller) to adjust the properties of the light (e.g. intensity, wavelength) emitting from the light source. In another embodiment, the light generating device contains at least a controller to adjust the properties of the light emitting from the light source. In another embodiment, power to the light source is provided wirelessly, so that no cables, including a power cord, are exposed. In another embodiment, the light generating device electrically connects to electrical connectors throughout the lighting system, and eventually electrically connects to a power cord.

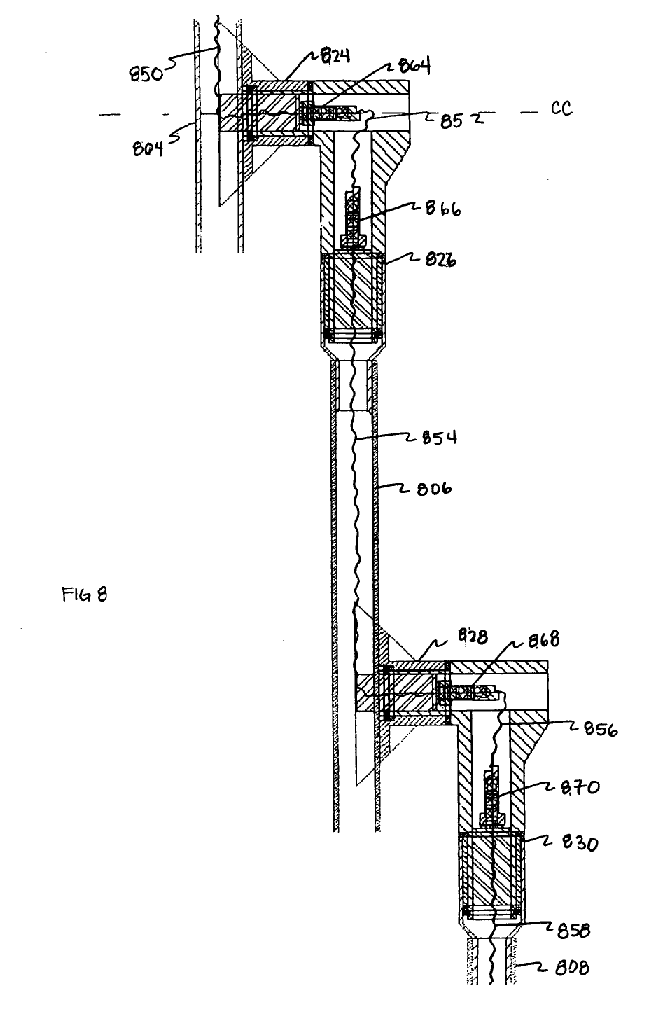

FIG. 8 is a cross-sectional view of electrical cables housed within joints and support arms in accordance with one embodiment of this invention. In FIG. 8, a light source (not shown) mechanically couples to support arm 804. The light source electrically connects to electrical cable 850 housed inside support arm 804. Cable 850 is connected to electrical connector 864 inside joint 824. Connector 864 connects via electrical cable 852 to electrical connector 866 housed inside joint 826. For example, the electrical connector 864 may include an electrical jack and an electrical plug, and this electrical jack may be coupled to cable 850 and the electrical plug may be coupled to cable 852. The jack and the plug form a rotatable electrical connection between cables 850 and 852. Connector 866 connects to electrical cable 854, which is housed inside support arm 806. Cable 854 is connected to electrical connector 868 in joint 828. Connector 868 connects via electrical cable 856 to electrical connector 870 housed inside joint 830. Connector 870 connects to electrical cable 858, which is housed inside support arm 808. Therefore, in the embodiment shown in FIG. 8, no cables are exposed along the path from the light source to support arm 808.

In one embodiment, each of joints 824, 826, 828 and 830 are rotatable and houses an electrical connector having an electrical jack and an electrical plug, such that each electrical jack and plug are capable of rotating relative to each other. Such a joint is described in U.S. patent application having attorney docket No. 007144.P003. In such an embodiment, for example, support arm 804 and joint 824 are rotably coupled such that support arm 804 is capable of rotating 360 degrees around axis CC defined by joint 824 even though cable 850 is housed within support arm 804. Electrical connector 864 allows cable 850 to electrically connect to cable 852. Because electrical connector 864 includes components capable of rotating relative to each other (e.g. a jack and plug), electrical connector 864 also allows cable 850 to remain substantially stationary relative to the support arm 804 while the support arm 804 rotates relative to the joint 824. In other words, support arm 804 and cable 850 are capable of rotating relative to joint 824 while maintaining continuous electrical connectivity with cable 852. It will be appreciated that each joint coupling of this invention may be so structured so as to provide freedom of movement and continuous electrical connectivity throughout the entire range of movement.

In one embodiment, support arm 808 has an opening through which cable 858 exits. In one embodiment, coupled to support arm 808 is a base (not shown), which has an opening through which cable 858 exits. In another embodiment, cable 858 connects to an electrical connector inside the base, which is capable of being coupled to a power source.

Thus, a lighting system providing, in at least certain embodiments, multiple degrees of freedom of motion is disclosed. Although the present invention is described herein with reference to a specific preferred embodiment, many modifications and variations therein will readily occur to those with ordinary skill in the art. Accordingly, all such variations and modifications are included within the intended scope of the present invention as defined by the following claims.

What is claimed is:

1. A light providing device comprising:
a light source;
a first rod coupled to the light source;
a second rod moveably coupled to the first rod;
a third rod moveably coupled to the second rod; and
a base coupled to the third rod, wherein the light source is capable of being moved in six degrees of freedom relative to the base.

2. A light providing device as in claim 1, wherein the light source is at least one of (a) light emitting diodes and (b) a halogen light bulb.

3. A light providing device as in claim 1, further comprising a rotatably movable electrical connector capable of providing current to the light source while the light source is moving relative to the base.

4. A light providing device as in claim 1, wherein one end of the first rod is more massive than a second end, the second end to couple to the light source.

5. A light providing device as in claim 1, wherein the light source is to have two degrees of freedom relative to the first rod, the first rod is to have two degrees of freedom relative to the second rod, and the second rod is to have two degrees of freedom relative to the third rod.

6. A light providing device as in claim 1, wherein the second rod is to have one degree of freedom relative to the third rod, and the third rod is to have one degree of freedom relative to the base.

7. A light providing device comprising:
a light source;
a counterweight coupled to the light source, the counterweight being a heatsink which conveys heat away from the light source; and
a joint coupled between the light source and the counterweight and coupled to a support arm, the joint providing at least one degree of freedom in moving the light source and the counterweight relative to the support arm.

8. A light providing device as in claim 7, further comprising a fan coupled to the counterweight.

9. A light providing device as in claim 7, wherein the joint comprises a first rotational joint and a second rotational joint providing two degrees of freedom of movement for the light source and counterweight relative to the support arm.

10. A light providing device as in claim 7, wherein the light source is at least one of (a) light emitting diodes (LEDs) and (b) a halogen light bulb.

11. A light providing device as in claim 7, wherein the counterweight substantially balances the light source and counterweight about an axis of rotation defined by the first rotational joint.

12. A light providing device, comprising:
a first rod;
a first counterweight coupled to the first rod;
a second rod;
a second counterweight coupled to the second rod;
a combination joint coupled to the first rod and to the second rod, the combination joint providing two degrees of freedom of movement relative to the first and second rod; and
a light generating device coupled to the second rod.

13. A light providing device as in claim 12, wherein the combination joint comprises a first joint to couple axially to the first rod and a second joint to couple orthogonally to the second rod.

14. A light providing device as in claim 12, wherein the second rod is capable of rotating less than 360 degrees about an axis perpendicular to another axis defined by the first rod.

15. A light providing device as in claim 12, further comprising:
a first cable stationarily disposed within the first rod, the first cable to electrically couple at one end to a power source and at another end to a first set of electrical connectors rotatably disposed within the combination joint; and
a second cable stationarily disposed within the second rod, the second cable to electrically couple at one end to the light generating device and at another end to a second set of electrical connectors rotatably disposed within the combination joint, the second set of electrical connectors to couple electrically to the first set of electrical connectors.

16. A light providing device as in claim 12, wherein the light generating device comprises:
a light emitting device; and
a rotatable electrical connector to receive energy to power the light emitting device.

17. A light providing device as in claim 12, wherein at least the first rod or the second rod comprises a rigid conductive core surrounded coaxially by an insulator, the conductive core to provide energy to the light generating device.

18. A light providing device comprising:
a light source and a heatsinking counterweight which is coupled to the light source;
a first rod having a first counterweight;
a first rotational joint and a second rotational joint movably coupling the first rod to the light source and to the heatsinking counterweight, the first rotational joint and the second rotational joint being coupled between the light source and the heatsinking counterweight;
a second rod having a second counterweight;
a third rotational joint and a fourth rotational joint moveably coupling the second rod to the first rod, the third rotational joint and the fourth rotational joint being coupled between the light source on one end of the first rod and the first counterweight on another end of the first rod;
a third rod;
a fifth rotational joint and a sixth rotational joint moveably coupling the third rod to the second rod, the fifth rotational joint and the sixth rotational joint being coupled between the third and fourth rotational joints on one end of the second rod and the second counterweight on another end of the second rod; and
a base coupled to the third rod.

19. A light providing device as in claim 18, wherein each rotational joint comprises a first electrical connector coupled to a second electrical connector, the first electrical connector rotatable relative to the second electrical connector.

20. A light providing device as in claim 19, wherein the first electrical connector is a four-position plug and the second electrical connector is a four-position jack.

21. A light providing device as in claim 19, wherein the first electrical connector is rotatable less than 360 degrees relative to the second electrical connector.

22. A light providing device as in claim 18, further comprising:
a first cable stationarily disposed within the first rod;
a second cable stationarily disposed within the second rod and coupled to the first cable; and
a third cable stationarily disposed within the third rod and coupled to the second cable, the first, second and third cables capable of providing an electrical signal to the light source while the light source moves relative to the base.

23. A light providing device as in claim 18, further comprising a third counterweight coupled to the third rotational joint and the fourth rotational joint, the third counterweight disposed perpendicular both to an axis defined by the first rod and to another axis defined by the second rod.

24. A light providing device as in claim 18, wherein the base comprises a top surface angled relative to a bottom surface.

25. A light providing device as in claim 18, wherein the third rod is coupled substantially closer to one base edge than another base edge.

26. A device, comprising:
a first joint combination to couple a first rod to an electromagnetic energy radiation source;
a second joint combination to couple a second rod to the first rod; and
a third joint combination to couple a third rod to the second rod, wherein the first, second and third joint combinations together provide six degrees of freedom of movement to the electromagnetic energy radiation source.

27. A device as in claim 26, wherein:
the first joint combination has means to move the electromagnetic energy radiation source in two degrees of freedom relative to the first rod;
the second joint combination has means to move the first rod in two degrees of freedom relative to the second rod; and
the third joint combination has means to move the second rod in two degrees of freedom relative to the third rod.

28. A device as in claim 26, wherein each joint combination further has means to provide electrical connectivity to the electromagnetic energy radiation source while the electromagnetic energy radiation source is moving relative to the third rod.
